(19) United States
(12) Patent Application Publication
(10) Pub. No.: US 2026/0338635 A1
(43) Pub. Date: Oct. 29, 2026

(54) LASER PROCESSING DEVICE AND LASER HEAD ABNORMALITY DETECTION METHOD

(71) Applicant: Panasonic Intellectual Property Management Co., Ltd., Osaka (JP)

(72) Inventors: Masatoshi NISHIO, Osaka (JP); Shunsuke KAWAI, Osaka (JP); Naohiro MURAYAMA, Osaka (JP); Jin MATSUZAKA, Osaka (JP); Jingbo WANG, Hyogo (JP)

(21) Appl. No.: 19/703,502

(22) Filed: Jun. 10, 2026

Related U.S. Application Data
(63) Continuation of application No. PCT/JP2024/045488, filed on Dec. 23, 2024.

(30) Foreign Application Priority Data
Dec. 25, 2023 (JP) 2023-218463

(51) Int. Cl. G01M 11/02; B23K 26/70

(52) U.S. Cl. CPC G01M 11/0242; B23K 26/705

(57) ABSTRACT

A laser processing device includes at least a laser oscillator configured to generate a laser beam, a laser head configured to irradiate a workpiece with the laser beam, and a control unit. The laser head accommodates at least a first lens for condensing the laser beam toward the workpiece, a first glass that transmits the laser beam, and one or more first sensors disposed between the first lens and the first glass in an irradiation direction of the laser beam to the workpiece. The control unit detects presence or absence of an abnormality in at least one of the first lens and the first glass based on a detection output of the first sensor.

### CROSS-REFERENCE TO RELATED APPLICATIONS

This is a continuation of International Application No. PCT/JP2024/045488 filed on Dec. 23, 2024, and claims priority from Japanese Patent Application No. 2023-218463 filed on Dec. 25, 2023, the entire content of which is incorporated herein by reference.

### TECHNICAL FIELD

The present disclosure relates to a laser processing device and a laser head abnormality detection method.

### BACKGROUND ART

Patent Literature 1 discloses a method of checking a condition related to contamination on a protective glass disposed between a workpiece and a laser optical element in a laser machining system. The protective glass is disposed so that a machining laser beam passes therethrough. A thermal detector senses a temperature of the protective glass or a holder thereof, and is disposed so as to have good thermal contact by mechanically contacting the holder.

Patent Literature 2 discloses a contamination detection device for a protective glass in a laser welding machine, which protects a laser head from contamination due to scattered deposits such as spatters or fumes from a weldment. The contamination detection device includes a bandpass filter that transmits light of a specific wavelength from scattered light emitted from a side surface of the protective glass, and a photosensor that detects transmitted light transmitted through the bandpass filter.

### Citation List

### Patent Literature

Patent Literature 1: JP2002-515341A
Patent Literature 2: JP2019-195814A

### SUMMARY OF INVENTION

The present disclosure has been made in view of the circumstances of the related art, and an object of the present disclosure is to provide a laser processing device and a laser head abnormality detection method that easily detect presence or absence of contamination on an optical element or the like inside a laser head that irradiates a workpiece with a laser beam.

### SOLUTION TO PROBLEM

The present disclosure provides a laser processing device including at least a laser oscillator configured to generate a laser beam, a laser head configured to irradiate a workpiece with the laser beam, and a control unit, in which the laser head accommodates at least a first lens for condensing the laser beam toward the workpiece, a first glass that transmits the laser beam, and one or more first sensors disposed between the first lens and the first glass in an irradiation direction of the laser beam to the workpiece, and the control unit detects presence or absence of an abnormality in at least one of the first lens and the first glass based on a detection output of the first sensor.

The present disclosure provides a laser head abnormality detection method executed by a laser processing device, the laser processing device including at least a laser oscillator configured to generate a laser beam, a laser head configured to irradiate a workpiece with the laser beam, and a control unit, in which the laser head accommodates at least a first lens for condensing the laser beam toward the workpiece, a first glass that transmits the laser beam, and one or more first sensors disposed between the first lens and the first glass in an irradiation direction of the laser beam to the workpiece. The method includes a step of, by the control unit, acquiring a detection output of the first sensor, and a step of, by the control unit, detecting presence or absence of an abnormality in at least one of the first lens and the first glass based on the detection output of the first sensor.

According to the present disclosure, it is possible to easily detect the presence or absence of an abnormality in the optical element or the like inside the laser head that irradiates a workpiece with a laser beam.

### BRIEF DESCRIPTION OF DRAWINGS

FIG. 1 is a schematic diagram illustrating a configuration example of a laser processing device according to the present embodiment;

FIG. 2A is a diagram illustrating a first example of a profile of a laser beam;

FIG. 2B is a diagram illustrating a second example of a profile of a laser beam;

FIG. 3 is a schematic diagram illustrating a perspective view of an inner side surface of a laser head;

FIG. 4 is a schematic diagram illustrating an example of a state in which a protective glass holder is inserted into an upper head block;

FIG. 5 is a schematic diagram illustrating an example of a state in which the protective glass holder is inserted into a lower head block;

FIG. 6 is a diagram illustrating an example of a threshold table stored in a memory; and

FIG. 7 is a flowchart illustrating an operation procedure of detecting presence or absence of an abnormality inside the laser head by a head processing unit of the laser processing device in time series.

### DESCRIPTION OF EMBODIMENTS

### Background of Present Disclosure

During laser processing, a surface of a protective glass disposed in the vicinity of an output end of an optical element (for example, a lens) inside a laser head is gradually contaminated by scattered deposits such as fumes or spatters generated from a workpiece as a processing target by irradiation with a laser beam. The protective glass may be disposed not only in the vicinity of the output end of the optical element but also on an upper side of the laser head in order to prevent contamination when the optical fiber is inserted and removed, for example. When the contamination of the protective glass accumulates, a decrease in laser output, a focus shift, and the like occur. That is, it is considered that the optical element in the laser head is burned out in the worst case because a workpiece quality by the laser processing is adversely affected, and it is necessary for an operator to clean or replace the protective glass in order to avoid such a situation as burnout.

In the configuration of Patent Literature 1, when an abnormality due to a temperature rise value is detected, there is a possibility that contamination such as damage to the optical element has already progressed, and there is a possibility that contamination inside the laser head has secondarily occurred. In the configuration of Patent Literature 2, it is possible to detect contamination on the protective glass alone, but there is a problem that it is difficult to detect whether there is an abnormality (for example, characteristic deterioration) in an optical element such as a lens disposed inside the laser head.

The abnormality of the protective glass alone may correspond to a decrease in laser output due to contamination by scattered deposits such as fumes or spatters, or damage to the protective glass. However, since the protective glass is often an expensive product that is used to obtain a constant transmittance even when a high-power laser is used, there is a demand for using the protective glass as long as possible. Further, it has been necessary to detect deterioration of an anti-reflection (AR) coating applied to each of the protective glass and the optical element and to detect contamination of the optical element other than the protective glass inside the laser head in long-term use. That is, since there are factors that cause processing defects in laser processing in addition to the protective glass, in order to reduce a downtime from occurrence of an abnormality to restart of processing as much as possible, it is required to investigate the cause that causes quality deterioration of laser processing at an early stage.

Therefore, in the following embodiment, examples of a laser processing device and a laser head abnormality detection method that easily detect presence or absence of an abnormality in an optical element or the like inside a laser head that irradiates a workpiece with a laser beam will be described.

Hereinafter, an embodiment specifically disclosing a laser processing device and a laser head abnormality detection method according to the present disclosure will be described in detail with reference to the drawings as appropriate. However, unnecessarily detailed description may be omitted. For example, detailed description of well-known matters and redundant description of substantially the same configuration may be omitted. This is to avoid unnecessary redundancy of the following description and to facilitate understanding of a person skilled in the art. The accompanying drawings and the following description are provided for a person skilled in the art to fully understand the present disclosure, and are not intended to limit the subject matter described in the claims.

### 1. Definition of Terms

In the following description, the term “laser processing” has the broadest possible meaning unless otherwise specified, and “processing” may be replaced with “welding”. “Processing” and “welding” are concepts including processing such as soldering, melt refining, joining, annealing, softening, adhesion, resurfacing, peening, heat treatment, fusion, sealing, stacking, cutting, and ablation.

In the following description, terms “blue laser beam” and “blue laser” have broadest possible meaning unless otherwise specified, and refer to a laser beam or light having a blue wavelength band (for example, a wavelength of about 400 nm to about 500 nm). In addition, terms “infrared”, “infrared light”, and “NIR” have broadest possible meaning unless otherwise specified, and refer to a laser beam or light having a near-infrared wavelength band (for example, a wavelength of 900 nm to 1000 nm).

### 2. Configuration of Laser Processing Device

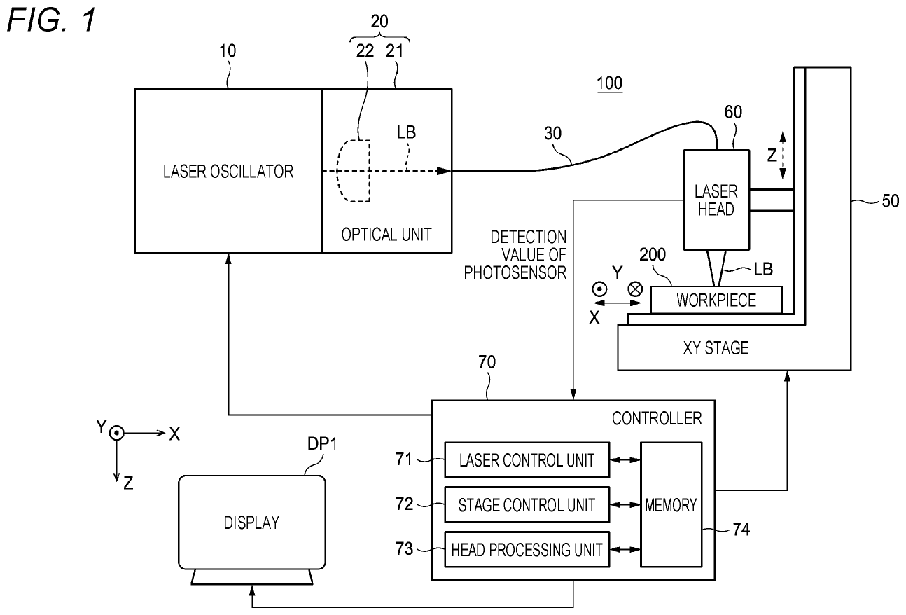

First, a configuration of a laser processing device 100 according to the present embodiment will be described with reference to FIG. 1.

FIG. 1 is a schematic diagram illustrating a configuration example of the laser processing device 100 according to the present embodiment. In the following description, an irradiation direction of laser beam LB from a laser head 60 toward a workpiece 200 is referred to as a Z direction. A direction intersecting an X direction on a surface of the workpiece 200 illustrated in FIG. 1 may be referred to as a Y direction. A direction intersecting each of the X direction and the Y direction may be referred to as a Z direction. In the Z direction, a side on which the laser head 60 is disposed with respect to the workpiece 200 may be referred to as top or an upper side, and a side on which the workpiece 200 is disposed with respect to the laser head 60 may be referred to as bottom or a lower side.

As illustrated in FIG. 1, the laser processing device 100 includes a laser oscillator 10, an optical unit 20, an optical fiber 30, an XY stage 50, a laser head 60, and a controller 70. The controller 70 includes a laser control unit 71, a stage control unit 72, a head processing unit 73, and a memory 74. A display DP1 having a function as a monitor for displaying a screen of a processing result by each unit of the controller 70 is connected to the controller 70.

The laser oscillator 10 generates the laser beam LB based on a command from the laser control unit 71 of the controller 70, and emits the laser beam LB toward the optical unit 20. In the present embodiment, a wavelength of the laser beam LB may be, for example, about 900 nm to 1000 nm, which is a wavelength band of the infrared laser, and an output may be about 1 kW to 5 kW. However, the present disclosure is not particularly limited thereto, and each of the values may be another value, and for example, when the laser beam LB is a blue laser, a wavelength band thereof may have a wavelength of about 400 nm to 500 nm, and an output may be about 0.4 kW. That is, the laser oscillator 10 can generate the laser beam having a wavelength band and an output corresponding to the command based on the command from the laser control unit 71. Further, the laser oscillator 10 may include another laser beam source (not illustrated), and may emit guide laser beam from the other laser beam source. A wavelength of the guide laser beam is, for example, visible light of about 650 nm, and an output is about several mW to several tens of mW, which is considerably lower than the output of the laser beam LB described above. An optical axis of the guide laser beam substantially coincides with an optical axis of the laser beam LB.

Although not illustrated, the laser oscillator 10 may include a plurality of laser modules and a beam combiner, which may be used to generate the laser beam LB of a blue laser beam. In the laser oscillator 10, laser beams of different wavelengths (different wavelengths such as 400 nm, 420 nm, 440 nm, and 480 nm in a range of about 400 nm to 500 nm) emitted from a plurality of laser modules are combined into one blue laser beam by the beam combiner. The laser oscillator 10 may be referred to as a direct diode laser (DDL) oscillator. The laser module itself includes a plurality of laser diodes, and is implemented by, for example, a semiconductor laser array.

Note that, in the present specification, “substantially coincide” or “substantially orthogonal” includes a machining tolerance and an assembly tolerance of each component constituting the laser processing device 100, and refers to the fact that objects being compared are coincides with each other or orthogonal to each other, but does not mean that the objects being compared are coincides with each other or orthogonal to each other in a strict sense.

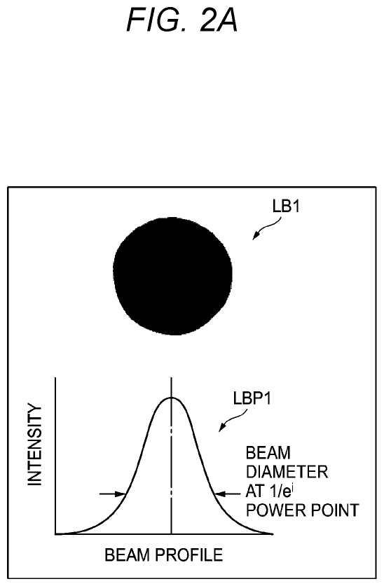

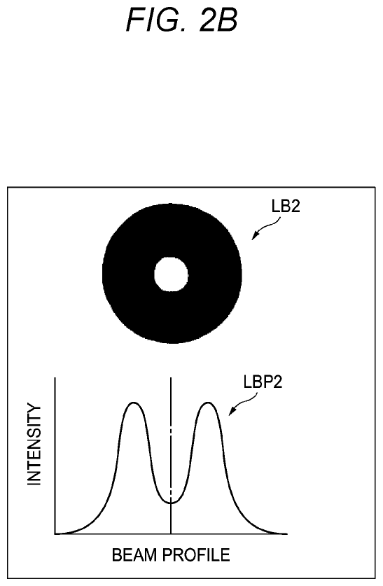

Here, profiles of the laser beam generated from the laser oscillator 10 will be described with reference to FIGS. 2A and 2B. FIG. 2A is a diagram illustrating a first example of the profile of the laser beam. FIG. 2B is a diagram illustrating a second example of the profile of the laser beam.

In a profile LBP1 of a laser beam LB1 illustrated in a lower part of FIG. 2A, a horizontal axis represents a distance from a center of the optical axis of the laser beam LB1, and a vertical axis represents an intensity of the laser beam LB1. The profile LBP1 in FIG. 2A has a characteristic (in other words, an oscillation mode) that the intensity is highest at a center portion of the laser beam LB1 and the intensity is gradually decreases as the distance from the center increases, and has a so-called Gaussian distribution. Hereinafter, the oscillation mode of the profile LBP1 may be referred to as Gaussian.

In a profile LBP2 of a laser beam LB2 illustrated in a lower part of FIG. 2B, a horizontal axis represents the distance from the center of the optical axis of the laser beam LB2, and a vertical axis represents an intensity of the laser beam LB2. The profile LBP2 in FIG. 2B has a characteristic that the intensity at a position slightly away from the center of the laser beam LB2 is higher than the intensity at the center portion of the laser beam LB1, and the intensity gradually decreases as the distance from the position increases, and has a so-called doughnut-shaped distribution or ring-shaped distribution. Hereinafter, the oscillation mode of the profile LBP2 may be referred to as a ring.

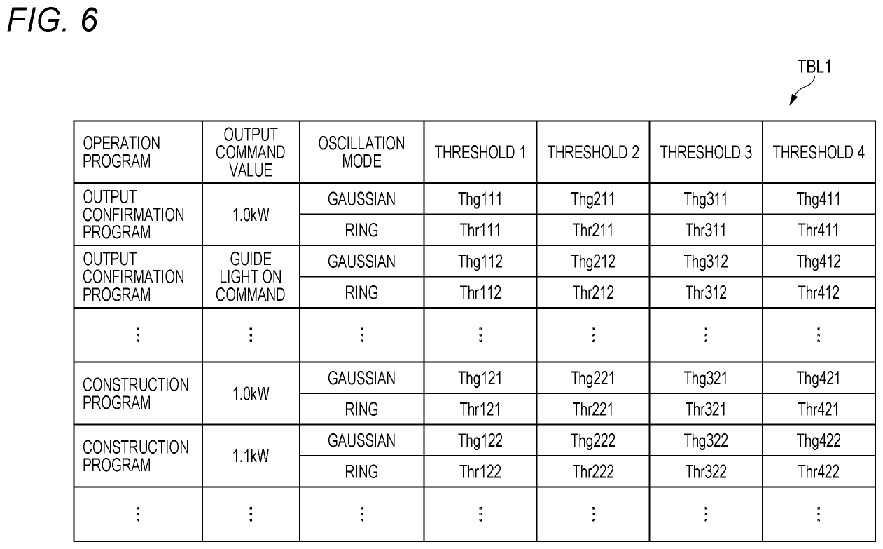

As described above, in the present embodiment, the laser beam LB generated from the laser oscillator 10 has at least one of the different profiles LBP1 and LBP2 as illustrated in FIGS. 2A and 2B. Therefore, various thresholds (see FIG. 6) are set in advance according to the profile so that the presence or absence of an abnormality (see below) of the laser head 60 is appropriately determined regardless of which profile of the laser beam is irradiated to the workpiece 200. The term “abnormality” as used herein refers to, for example, a situation in which at least one of contamination, a scratch, and deterioration occurs in an optical element (described later) or a protective glass disposed in the laser head 60, and the same applies to the following description. Here, two types of laser beams LB1 and LB2 are exemplified as the profile of the laser beam LB generated from the laser oscillator 10, but it is needless to say that the profile of the laser beam LB is not limited thereto.

The optical unit 20 includes a housing 21. The optical unit 20 accommodates a condensing lens 22 inside the housing 21. The condensing lens 22 condenses the laser beam LB incident into the housing 21, and causes the condensed laser beam LB to be incident on the optical fiber 30. In order to align a condensing position of the laser beam LB with an incident end surface of the optical fiber 30, a condensing position adjustment mechanism (not illustrated) may be further provided in the optical unit 20.

One end side of the optical fiber 30 is connected to the optical unit 20, and the other end side is connected to an upper end of the laser head 60. The optical fiber 30 transmits the laser beam LB incident from the optical unit 20 or the guide laser beam to the laser head 60. Although not illustrated, the optical fiber 30 includes one or more cores, which are waveguides of the laser beam LB or the guide laser beam.

The XY stage 50 includes a stage on which the workpiece 200 is placed, and displaces the workpiece 200 by a movement amount corresponding to a command in both the X direction and the Y direction based on the command from the controller 70 (specifically, the stage control unit 72). The XY stage 50 may have a known configuration as long as the XY stage 50 can drive the placed workpiece 200 in a two-dimensional direction. The XY stage 50 may hold the laser head 60 in a fixable manner during any operation program to be described later, or may move the laser head 60 up and down along the Z direction by a predetermined amount corresponding to the command based on the command from the controller 70 (specifically, the stage control unit 72), for example. A cable (not illustrated) provided between the controller 70 and the XY stage 50 accommodates a cooling hose (not illustrated) of the laser head 60 and an I/O line (not illustrated) such as a thermal switch. Further, an XY direction movement of the workpiece 200 and a Z direction movement of the laser head 60 may be executed via a manipulator (not illustrated) controllable by the controller 70 instead of the XY stage 50.

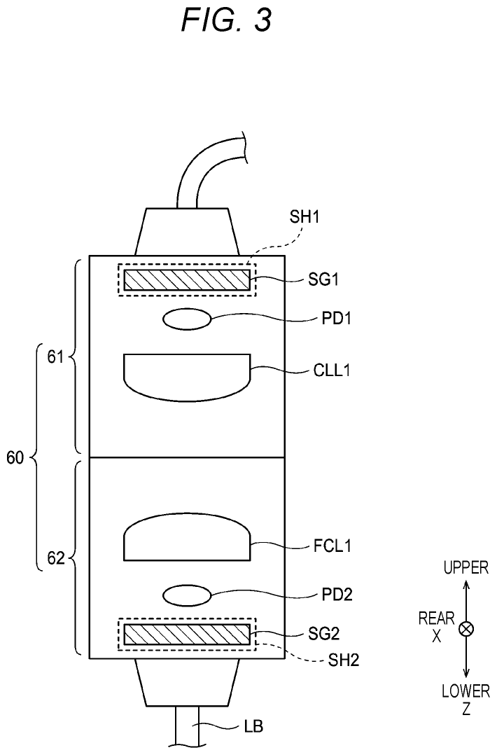

The laser head 60 is attached to a holding portion (not illustrated) of the laser head 60 provided on the XY stage 50. The laser head 60 irradiates the workpiece 200 with the laser beam LB or the guide laser beam transmitted from the optical fiber 30 to the laser head 60. As a result, the laser head 60 emits the laser beam LB, and the workpiece 200 is laser-processed by the laser beam LB. The laser head 60 includes an optical system (for example, a collimation lens and a condensing lens) and a photosensor (see FIG. 3), and converts the laser beam LB into parallel light and then condenses the parallel light on the surface of the workpiece 200. An internal structure example of the laser head 60 will be described later with reference to FIG. 3. The photosensor and the controller 70 are connected so that data of a value detected by the photosensor can be input to the controller 70.

The controller 70 controls the operation (for example, generation or stop) of the laser beam LB or the guide laser beam by the laser oscillator 10, and controls the operation of the XY stage 50 (for example, the movement of the workpiece 200 in the XY direction and the movement of the laser head 60 in the Z direction). Further, the controller 70 determines the presence or absence of an abnormality of the laser head 60 (for example, contamination, a scratch, or deterioration of the optical element or the protective glass in the laser head 60) based on data of a value detected by the photosensor (see FIG. 3) disposed in the laser head 60. As described above, the controller 70 includes the laser control unit 71, the stage control unit 72, the head processing unit 73, and the memory 74.

The laser control unit 71 is electrically connected to the laser oscillator 10 and controls an operation of the laser oscillator 10. The laser control unit 71 controls an operation of a laser driving power supply (not illustrated) connected to the laser oscillator 10. Specifically, the laser oscillator 10 controls the output of the laser beam LB or the guide laser beam, oscillation time, and oscillation start and stop timings of the laser beam LB or the guide laser beam based on the control (command) from the laser control unit 71.

The stage control unit 72 generates a command for moving (scanning) a mounting table of the XY stage 50 on which the workpiece 200 to be laser-processed is mounted in the XY direction (that is, two-dimensional), and sends the command to the XY stage 50. Accordingly, the XY stage 50 can irradiate the workpiece 200 with the laser beam LB emitted from the laser head 60 by moving the mounting table in the XY direction by the movement amount designated by the command based on the command from the stage control unit 72.

The controller 70 includes the head processing unit 73 for detecting the presence or absence of an abnormality in the optical element and the protective glass (see FIG. 3) inside the laser head 60 based on data of a value detected by the photosensor (see FIG. 3) inside the laser head 60.

The head processing unit 73 detects the presence or absence of an abnormality in the optical element and the protective glass (see FIG. 3) inside the laser head 60 based on detection values of one or more photosensors (see FIG. 3) disposed inside the laser head 60 and the threshold table (see FIG. 6) stored (registered) in the memory 74. The head processing unit 73 generates a screen indicating the detection result (for example, a message indicating that there is no contamination, a message prompting cleaning or replacement because contamination is accumulated, or an error output indicating that use should be prohibited because contamination is severe) and displays the screen on the display DP1, or stops the operation of the laser oscillator 10 based on the detection result.

The memory 74 includes a random access memory (RAM) and a read only memory (ROM). The RAM temporarily stores data or information acquired or generated by each of the laser control unit 71, the stage control unit 72, and the head processing unit 73. The ROM stores programs and data used for various processing executed by the laser control unit 71, the stage control unit 72, and the head processing unit 73. The memory 74 stores (registers) data of the threshold table (see FIG. 6) to be referred to at the processing when the head processing unit 73 detects the presence or absence of an abnormality in the optical element and the protective glass (see FIG. 3) inside the laser head 60. This data may be appropriately corrected and stored (registered) as necessary at a timing other than an operation of the laser processing device 100.

Here, the threshold table TBL1 will be described with reference to FIG. 6. FIG. 6 is a diagram illustrating an example of the threshold table TBL1 stored in the memory 74.

The threshold table TBL1 has a plurality of records of one row including an operation program, an output command value, an oscillation mode, a threshold 1, a threshold 2, a threshold 3, and a threshold 4. Although not illustrated in FIG. 6, the threshold 5 (not illustrated) may be further included in the same record. The operation program includes an output confirmation program for determining whether various abnormalities inside the laser head 60 or signs thereof are detected using the laser beam LB or the guide laser, and a construction program for performing an actual process (processing) using the laser beam LB. When the operation program is used, there are a teach mode in which the laser beam LB is not emitted and an auto mode in which the laser beam LB is emitted. In order to execute the output confirmation program, the teach mode using the guide laser beam may be used, or the auto mode using the actual processing laser beam LB may be used.

For example, in order to determine various thresholds of the threshold table TBL1, a power meter that absorbs the laser beam LB is disposed instead of the workpiece 200 on the mounting table of the XY stage 50, which is a displacement location of the workpiece 200, and an appropriate threshold for the auto mode is determined in advance by the output of the power meter that absorbs the laser beam using the laser beam LB of the wavelength, the output, and the oscillation mode used at the time of the process (actual processing) of the auto mode. When the construction program in the auto mode is used, unlike in the teach mode, the workpiece 200, which is not a power meter but a workpiece, is placed on the mounting table of the XY stage 50, and processing (welding) is actually performed.

In order to determine various thresholds in the threshold table TBL1, a low output power meter that absorbs the guide laser beam may be disposed on the mounting table of the XY stage 50, which is the placement location of the workpiece 200, and an appropriate threshold for the teach mode may be determined in advance by the output of the low output power meter that absorbs the laser beam using the guide laser beam of the wavelength, the output, and the oscillation mode used in the teach mode. Accordingly, it is possible to easily predict and determine various abnormalities inside the laser head 60 or signs thereof by using the guide laser beam with a low output without using the laser beam used for the actual auto mode with a high output.

The threshold 1 is a detection value of each of photosensors PD1 and PD2 when an abnormality inside the laser head 60 is specifically detected due to burnout or ignition occurring in the respective one of the protective glasses SG1 and SG2 or optical elements (for example, a collimation lens CLL1 and a condensing lens FCL1. The same applies hereinafter in the description of FIG. 6) inside the laser head 60, and is a value greater than the threshold 2. For example, when an abnormality such as contamination, a scratch, or deterioration occurs in the protective glass or the optical element, an amount of light absorption of the laser beam incident on an abnormal location into the laser head increases and the amount of light absorption increases, so that a temperature increases. In this case, a coating film such as an AR coating applied to the protective glass or the optical element deteriorates, and the protective glass or the optical element generates heat due to further progress of absorption of the laser beam, which may cause burnout. Due to such heat generation, a small amount of residual oil or a volatile component of the resin component is generated, and thus characteristics of the protective glass or the optical element in the laser head may be deteriorated. Examples of the specific deterioration include a decrease in transmittance due to an oil film, an increase in scattered light due to adhesion of impurities, and occurrence of a thermal lens due to an increase in absorptivity of a laser beam. The threshold 1 is a threshold provided to immediately notify an operator or the like that an event has occurred that makes it unsuitable for continuous use of the optical element due to an adverse effect caused by such burnout. When a detection value equal to or greater than the threshold 1 is obtained, use of the device in the auto mode is stopped.

The threshold 2 is a detection value of each of the photosensors PD1 and PD2 when there is an increase in a precursory phenomenon of an abnormality that does not reach the level of an abnormality due to burnout or ignition in, for example, respective one of the protective glasses SG1 and SG2 or the optical element on the assumption that there is a possibility that an influence on respective one of the protective glass SG1 and SG2 or a peripheral element of the optical element inside the laser head 60 occurs (the threshold 1>the threshold 2). The threshold 1 and the threshold 2 are examples of an upper limit threshold. When the detection value equal to or greater than the threshold 2 is obtained, the use of the device in the auto mode is stopped as in the case where the detection value equal to or greater than the threshold 1 is obtained.

The threshold 3 is a detection value of each of the photosensors PD1 and PD2 when it is time to replace respective one of the protective glasses SG1 and SG2 due to start of deterioration of the coating film of the AR coating applied to the respective one of protective glasses SG1 and SG2 (the threshold 2>the threshold 3). When a detection value equal to or greater than the threshold 3 but less than the threshold 2 is obtained, it is assumed that there is a possibility that an abnormality may have occurred inside the laser head 60, and thus the use of the device in the auto mode is not stopped.

The threshold 4 is a detection value of each of the photosensors PD1 and PD2 when it is predicted that there is an abnormality (for example, an operation abnormality of the equipment due to a decrease in output or the like) in the equipment (for example, the laser oscillator 10, the optical unit 20, or the optical fiber 30) disposed upstream of the laser head 60. The threshold 4 is an example of a lower limit threshold.

Note that, in the threshold table illustrated in FIG. 6, various thresholds for the output confirmation program and various thresholds for the construction program are illustrated as being mixed, but the threshold table for the output confirmation program and the threshold table for the construction program may be provided as different tables. In this case, the head processing unit 73 may read the threshold table for the output confirmation program or the threshold table for the construction program according to the presence or absence of the reflected light from the workpiece, for example.

For example, in a record of “the output confirmation program, 1.0 kW, Gaussian, Thg111 (threshold 1), Thg211 (threshold 2), Thg311 (threshold 3), and Thg411 (threshold 4)”, the output confirmation program is executed, and when the output command value of the laser beam necessary at the time of executing the program is 1.0 kW which is the high output for the auto mode and the detection value of each of the photosensors PD1 and PD2 exceeds Thg111, it is determined that contamination, a scratch, or deterioration due to burnout or ignition is detected in the protective glasses SG1 and SG2 and the optical elements inside the laser head 60, and the operation is immediately stopped. Similarly, when the detection value of each of the photosensors PD1 and PD2 does not reach Thg111 but exceeds Thg211, the head processing unit 73 determines that a precursory phenomenon (for example, contamination, a scratch, or deterioration) of an abnormality that does not reach the level of contamination, a scratch, or deterioration due to burnout or ignition of the protective glasses SG1 and SG2 and the optical elements inside the laser head 60 is detected. Similarly, when the detection value of each of the photosensors PD1 and PD2 is less than Thg411, the head processing unit 73 determines that there is a high possibility that an abnormality (for example, an operation abnormality of the equipment) has occurred in the equipment (for example, the laser oscillator 10, the optical unit 20, or the optical fiber 30) disposed upstream of the laser head 60. In this case, since it is not preferable to continue the use of the equipment (for example, the laser oscillator 10, the optical unit 20, and the optical fiber 30) disposed on the upstream side in terms of the continuation of the operation of the laser processing device 100, it is preferable to replace the equipment at an early stage after displaying a message or the like indicating that it is difficult to continue the use on the display DP1.

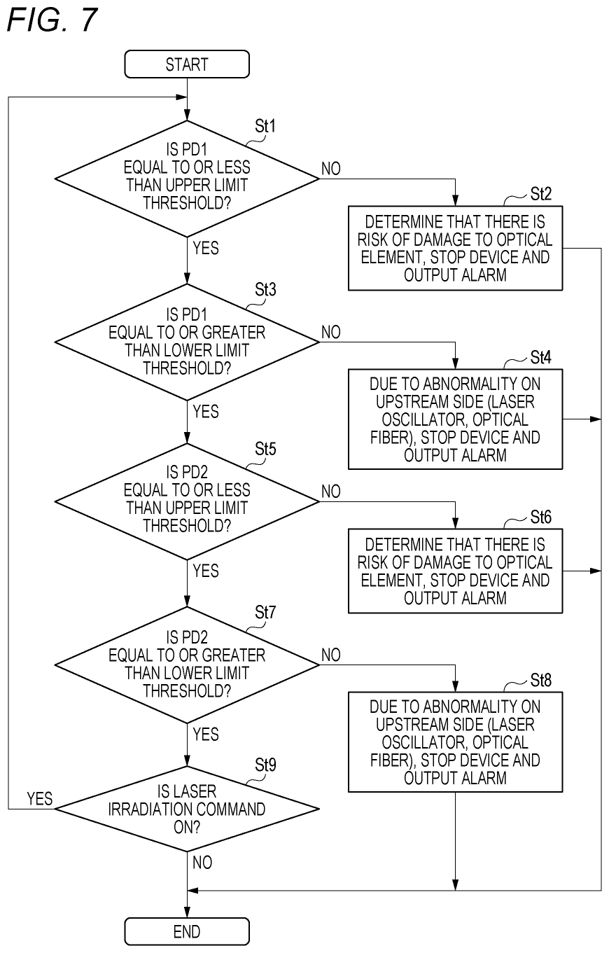

When the detection values of the photosensors PD1 and PD2 are abnormal (that is, exceeding the threshold 4) in both the output confirmation program and the construction program of the operation program regardless of the oscillation mode, it is estimated that there is an abnormality in the equipment (for example, the laser oscillator 10, the optical unit 20, and the optical fiber 30) of the laser processing device 100. The head processing unit 73 may determine the presence or absence of an abnormality (contamination or the like) of the equipment or the optical element of the laser processing device 100 by executing processing of FIG. 7 to be described later.

On the other hand, when the operation program is a construction program and the detection values of the photosensors PD1 and PD2 are substantially equal to the threshold (for example, the threshold 5) at the time of normal construction (that is, when laser processing is normally performed), it is estimated that there is no abnormality in the equipment (for example, the laser oscillator 10, the optical unit 20, and the optical fiber 30) of the laser processing device 100. The head processing unit 73 may determine the presence or absence of an abnormality (contamination or the like) of the equipment or the optical element of the laser processing device 100 by executing the processing of FIG. 7 to be described later.

On the other hand, when the operation program is the construction program and the detection values of the photosensors PD1 and PD2 are abnormal (that is, exceeding the threshold 3), deterioration of each AR coating of the protective glasses SG1 and SG2 is estimated. The head processing unit 73 may determine the presence or absence of an abnormality (contamination or the like) of the equipment or the optical element of the laser processing device 100 by executing processing of FIG. 7 to be described later.

For example, in a record of “the output confirmation program, a guide light ON command, a ring, Thr112, Thr212, Thr312, Thr412”, the output confirmation program is executed, and when the output command value of the guide laser beam necessary at the time of execution of the program is a predetermined value (for example, 0.005 kW) and the detection value of each of the photosensors PD1 and PD2 exceeds Thr112, it is simply determined that contamination, a scratch, or deterioration due to burnout or ignition is detected in the protective glasses SG1 and SG2 and the optical elements inside the laser head 60 without using the laser beam LB for actual processing (construction). Similarly, when the detection value of each of the photosensors PD1 and PD2 does not reach Thr112 but exceeds Thr212, the head processing unit 73 determines that a precursory phenomenon (for example, contamination, a scratch, or deterioration) of an abnormality that does not reach the level of contamination, a scratch, or deterioration due to burnout or ignition of the protective glasses SG1 and SG2 and the optical elements inside the laser head 60 is detected. Similarly, when the detection value of each of the photosensors PD1 and PD2 is less than Thr412, the head processing unit 73 determines that there is a high possibility that an abnormality (for example, the operation abnormality of the equipment) has occurred in the equipment (for example, the laser oscillator 10, the optical unit 20, or the optical fiber 30) disposed upstream of the laser head 60. In this case, since it is not preferable to continue the use of the equipment (for example, the laser oscillator 10, the optical unit 20, and the optical fiber 30) disposed on the upstream side in terms of the continuation of the operation of the laser processing device 100, it is preferable to replace the equipment at an early stage after displaying a message or the like indicating that it is difficult to continue the use on the display DP1.

When it is determined that the detection value of the photosensor PD1 is normal (for example, a value between the threshold 3 and the threshold 4) and the detection value of the photosensor PD2 is a lower limit abnormality (for example, a value less than the threshold 4), the head processing unit 73 determines that an abnormality has occurred in the protective glasses SG1 and SG2, or the optical element in the laser head 60.

The head processing unit 73 may determine the presence or absence of an abnormality in the protective glasses SG1 and SG2 and the optical elements inside the laser head 60 by combining the detection values of the photosensors PD1 and PD2 with different thresholds corresponding to the operation program, the output command value, and the oscillation mode. Although this is merely a limited example, the head processing unit 73 can make the following determination based on the detection values of the photosensors PD1 and PD2.

(Detection Example 1) Both detection values of the photosensors PD1 and PD2 are normal values (for example, between the threshold 3 and the threshold 4)

In this case, the head processing unit 73 determines that no abnormality has occurred in any of the protective glasses SG1 and SG2 and the optical elements inside the laser head 60, and outputs the determination result to the display DP1 or the like.

(Detection Example 2) When the detection value of the photosensor PD1 is the normal value (for example, between the threshold 3 and the threshold 4) but the detection value of the photosensor PD2 is the abnormal value (for example, the threshold 1 or more)

In this case, the head processing unit 73 determines that no abnormality occurs in the protective glass SG1 and the optical element (collimation lens CLL1) in the upper head block 61 of the laser head 60 and an abnormality occurs in at least one of the protective glass SG2 and the optical element (condensing lens FCL1) in a lower head block 62, and outputs the determination result to the display DP1 or the like.

(Detection Example 3) When the detection value of the photosensor PD2 is a normal value (for example, between threshold 3 and threshold 4) but the detection value of the photosensor PD1 is an abnormal value (for example, threshold 1 or more)

In this case, the head processing unit 73 determines that no abnormality occurs in the protective glass SG2 and the optical element (the condensing lens FCL1) in the lower head block 62 of the laser head 60 and an abnormality occurs in at least one of the protective glass SG1 and the optical element (the collimation lens CLL1) in the upper head block 61, and outputs the determination result to the display DP1 or the like.

(Detection Example 4) Both detection values of the photosensors PD1 and PD2 are abnormal values (for example, less than the threshold 4)

In this case, the head processing unit 73 determines that no abnormality has occurred inside the laser head 60 and an abnormality (for example, output reduction) has occurred in at least one of the laser oscillator 10, the optical unit 20, and the optical fiber 30 on the upstream side thereof, and outputs the determination result to the display DP1 or the like.

The display DP1 is implemented by, for example, a liquid crystal display (LCD) or an organic electroluminescence (EL) display, and is connected to the controller 70 to enable the input and output of data signals. The display DP1 displays a screen indicating a processing result by each unit of the controller 70 (for example, the message indicating that there is no contamination, the message prompting cleaning or replacement because contamination is accumulated, or the error output indicating that use should be prohibited because contamination is severe).

### 3. Structure of Laser Head

Next, a structure of the laser head 60 of the laser processing device 100 according to the present embodiment will be described with reference to FIGS. 3 to 5.

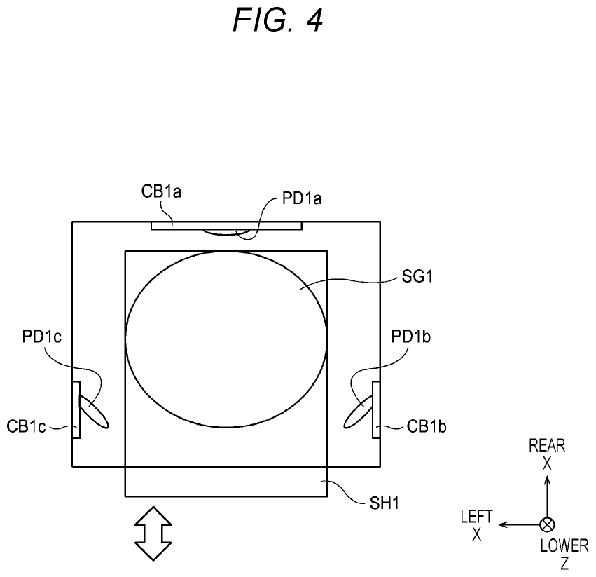

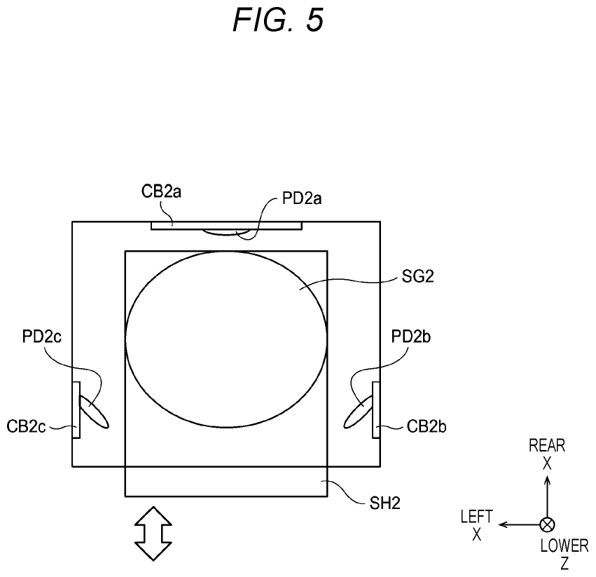

FIG. 3 is a schematic diagram illustrating a perspective view of an inner side surface of the laser head 60. FIG. 4 is a schematic diagram illustrating an example of a state in which a protective glass holder SH1 is inserted into the upper head block 61. FIG. 5 is a schematic diagram illustrating an example of a state in which a protective glass holder SH2 is inserted into the lower head block 62.

In the present embodiment, the laser head 60 has a structure in which the upper head block 61 and the lower head block 62 are connected to each other and are detachable from each other. That is, in the laser head 60, the upper head block 61 can be detached from the lower head block 62, and the lower head block 62 can be detached from the upper head block 61.

The upper head block 61 accommodates the protective glass SG1, the photosensor PD1, and the collimation lens CLL1 along the Z direction from top to bottom.

The collimation lens CLL1 has a function of collimation (that is, parallelization) of the laser beam LB guided from the optical fiber 30 into the laser head 60 and transmitted through the protective glass SG1.

The protective glass SG1 is held at a predetermined position of the protective glass holder SH1 having a constant thickness (Z direction) that is rectangular in an XY plane direction (see FIG. 4). The protective glass holder SH1 is formed to be insertable into and removable from the upper head block 61 of the laser head 60 in the X direction. That is, the protective glass SG1 can be easily replaced by being disposed in the protective glass holder SH1 and inserted into the upper head block 61.

In the present embodiment, for example, three photosensors PD1 are provided and disposed so as to surround the protective glass SG1 in the XY plane direction orthogonal to the Z direction (see FIG. 4). Specifically, three photosensors PD1a, PD1b, and PD1c are disposed. Each of the photosensors PD1a, PD1b, and PD1c receives scattered light in the upper head block 61 of the laser beam LB transmitted through the protective glass SG1 in the upper head block 61. Each of the photosensors PD1a, PD1b, and PD1c may have a light receiving sensitivity to light in the same wavelength band, or may have a light receiving sensitivity to light in different wavelength bands. For example, the photosensor PD1a may have a sensitivity in a wide band to an output wavelength (for example, 445 nm) of the laser beam LB, the photosensor PD1b may have a sensitivity only in the vicinity of the output wavelength (for example, 445 nm) of the laser beam LB, and the photosensor PD1c may have a sensitivity higher to an infrared region (for example, 900 nm) than to the output wavelength (for example, 445 nm) of the laser beam LB. Therefore, for example, when a detection value of the photosensor PD1c increases, it is assumed that a state of the reflected light of the laser beam based on a construction state of the workpiece 200 changes. On the other hand, for example, when the detection values of both the photosensors PD1a and PD1b similarly increase at the time of construction on the workpiece 200 of the same lot, it is assumed that there is an abnormality (contamination) in the laser oscillator 10 or the protective glass SG1 as the light source. The photosensors PD1a, PD1b, and PD1c are respectively disposed on substrates CB1a, CB1b, and CB1c, which are fixed to a part of a periphery of the upper head block 61. That is, the photosensors PD1a, PD1b, and PD1c and the controller 70 are connected to each other so that data signals of the detection values of the photosensors PD1a, PD1b, and PD1c can be input to the controller 70 via the substrates CB1a, CB1b, and CB1c, respectively.

As described above, depending on the arrangement of the photosensors PD1 (that is, the photosensors PD1a, PD1b, and PD1c) provided in the upper head block 61, the head processing unit 73 may determine that the detection values tend to increase in a certain period. In this case, the head processing unit 73 can determine that there is a possibility that the optical fiber 30 is also adversely affected, and can notify the operator or the like of the determination result by displaying the determination result on the display DP1. On the other hand, depending on the arrangement of the photosensors PD1 (that is, the photosensors PD1a, PD1b, and PD1c), the head processing unit 73 may determine that the detection values tend to decrease in a certain period. In this case, the head processing unit 73 can determine that there is a possibility of deterioration in characteristics of the laser oscillator 10 or deterioration in coating characteristics of the protective glass SG1, and can notify the operator or the like by displaying the determination result on the display DP1.

Instead of allowing the photosensors PD1a, PD1b, and PD1c to have the light receiving sensitivities to light in different wavelength bands, for example, filters (not illustrated) having light receiving sensitivities to light in different wavelength bands may be disposed in front of the photosensors PD1a, PD1b, and PD1c having the light receiving sensitivities to light in the same wavelength band. As a result, for example, even when the photosensors PD1a, PD1b, and PD1c have the light receiving sensitivities to light in the same wavelength band, photosensors having light receiving sensitivities to light in substantially different wavelength bands can be disposed.

The lower head block 62 accommodates the condensing lens FCL1, the photosensor PD2, and the protective glass SG2 along the Z direction from top to bottom.

The condensing lens FCL1 has a function of condensing the laser beam LB collimated by the collimation lens CLL1 toward the workpiece 200.

In the present embodiment, for example, three photosensors PD2 are provided and disposed so as to surround the protective glass SG2 in the XY plane direction orthogonal to the Z direction (see FIG. 5). Specifically, three photosensors PD2a, PD2b, and PD2c are disposed. Each of the photosensors PD2a, PD2b, and PD2c receives the scattered light of the laser beam LB collimated by the collimation lens CLL1 in the upper head block 61 or the scattered light of the reflected light from the workpiece 200 scattered by the protective glass SG2 or the like in the lower head block 62. Each of the photosensors PD2a, PD2b, and PD2c may have a light receiving sensitivity to light in the same wavelength band, or may have a light receiving sensitivity to light in different wavelength bands. For example, the photosensor PD2a may have a sensitivity in a wide band to the output wavelength (for example, 445 nm) of the laser beam LB, the photosensor PD2b may have a sensitivity only in the vicinity of the output wavelength (for example, 445 nm) of the laser beam LB, and the photosensor PD2c may have a sensitivity higher to the infrared region (for example, 900 nm) than to the output wavelength (for example, 445 nm) of the laser beam LB. Therefore, for example, when a detection value of the photosensor PD2c increases, it is assumed that the state of the reflected light of the laser beam based on the construction state of the workpiece 200 changes. On the other hand, for example, when the detection values of both the photosensors PD2a and PD2b similarly increase at the time of construction on the workpiece 200 of the same lot, it is assumed that there is an abnormality (contamination) in the laser oscillator 10 or the protective glass SG2 as the light source. The photosensors PD2a, PD2b, and PD2c are respectively disposed on substrates CB2a, CB2b, and CB2c, which are fixed to a part of a periphery of the lower head block 62. That is, the photosensors PD2a, PD2b, and PD2c and the controller 70 are connected to each other so that data signals of the detection values of the photosensors PD2a, PD2b, and PD2c can be input to the controller 70 via the substrates CB2a, CB2b, and CB2c, respectively.

Instead of allowing the photosensors PD2a, PD2b, and PD2c to have light receiving sensitivities to light in different wavelength bands, for example, filters having light receiving sensitivities to light in different wavelength bands may be disposed in front of the photosensors PD2a, PD2b, and PD2c having the light receiving sensitivities to light in the same wavelength band. As a result, for example, even when the photosensors PD2a, PD2b, and PD2c have light receiving sensitivities to light in the same wavelength band, photosensors having light receiving sensitivities to light in substantially different wavelength bands can be disposed.

The protective glass SG2 is held at a predetermined position of a protective glass holder SH2 having a constant thickness (Z direction) that is rectangular in the XY plane direction (see FIG. 5). The protective glass holder SH2 is formed to be insertable into and removable from the lower head block 62 of the laser head 60 in the X direction. That is, the protective glass SG2 can be easily replaced by being disposed in the protective glass holder SH2 and inserted into the lower head block 62.

As described above, depending on the arrangement of the photosensors PD2 (that is, the photosensors PD2a, PD2b, and PD2c) provided in the lower head block 62, the head processing unit 73 may determine that the detection value tends to decrease in a certain period. In this case, the head processing unit 73 can determine that there is a possibility of deterioration in the characteristics of the laser oscillator or deterioration in the coating characteristics of the protective glass SG1, and can notify the operator or the like by displaying the determination result on the display DP1.

4. Operation of Abnormality Detection inside Laser Head

Next, an operation of detecting the presence or absence of an abnormality (for example, contamination, a scratch, or deterioration) inside the laser head 60 by the head processing unit 73 will be described with reference to FIG. 7. FIG. 7 is a flowchart illustrating an operation procedure of detecting the presence or absence of an abnormality inside the laser head 60 by the head processing unit 73 of the laser processing device 100 in time series. Each processing illustrated in FIG. 7 is mainly executed by the head processing unit 73. In order to simplify the description of FIG. 7, the threshold 1 of the threshold table TBL1 described with reference to FIG. 6 is used as the upper limit threshold and the threshold 4 is used as the lower limit threshold, but the threshold 2 or the threshold 3 may be used as the lower limit threshold.

In FIG. 7, the head processing unit 73 acquires the average value or the maximum value of the detection values of the photosensors PD1a, PD1b, and PD1c (see FIG. 4) as the detection value of the photosensor PD1 (see FIG. 3). Similarly, the head processing unit 73 acquires the average value or the maximum value of the detection values of the photosensors PD2a, PD2b, and PD2c (see FIG. 5) as the detection value of the photosensor PD2 (see FIG. 3).

The head processing unit 73 determines whether the detection value of the photosensor PD1 is equal to or less than the upper limit threshold corresponding to the current operation program, oscillation mode, and command of the laser beam LB based on the current operation program, oscillation mode, and output (command) of the laser beam LB and the threshold table TBL1 read from the memory 74 (step St1). When it is determined that the detection value of the photosensor PD1 is greater than the upper limit threshold (step St1, NO), the head processing unit 73 determines that there is a risk of damage to the optical element inside the laser head 60 (for example, around the upper head block 61), controls turning off of a laser driving power supply (not illustrated) for stopping the operation of the laser processing device 100, generates a screen indicating a warning alarm (message) for prompting the operator to clean or replace the optical element, and displays the screen on the display DP1 (step St2). That is, when the optical element is burned out, the AR coating applied to the optical element is damaged, and the scattered light increases or intense light emission occurs due to the influence, so that the detection value of the photosensor PD1 increases. After step St2, the processing of the head processing unit 73 illustrated in FIG. 7 ends.

On the other hand, when it is determined that the detection value of the photosensor PD1 is equal to or less than the upper limit threshold (steps St1, YES), the head processing unit 73 determines whether the detection value of the photosensor PD1 is equal to or greater than the lower limit threshold corresponding to the current operation program, oscillation mode, and command of the laser beam LB (step St3). When it is determined that the detection value of the photosensor PD1 is less than the lower limit threshold (step St3, NO), the head processing unit 73 determines that there is a high possibility that an abnormality has occurred in the equipment (for example, the laser oscillator 10, the optical unit 20, or the optical fiber 30) disposed upstream of the laser head 60, controls turning off of the laser driving power supply (not illustrated) for stopping the operation of the laser processing device 100, generates a screen indicating a warning alarm (message) for prompting the operator to inspect or replace the equipment (refer to the above description), and displays the screen on the display DP1 (step St4). After step St4, the processing of the head processing unit 73 illustrated in FIG. 7 ends.

On the other hand, when it is determined that the detection value of the photosensor PD1 is equal to or greater than the lower limit threshold (steps St3, YES), the head processing unit 73 determines that there is no abnormality in the detection value of the photosensor PD1. Subsequently, the head processing unit 73 determines whether the detection value of the photosensor PD2 is equal to or less than the upper limit threshold corresponding to the current operation program, oscillation mode, and command of the laser beam LB based on the current operation program, oscillation mode, and output (command) of the laser beam LB and the threshold table TBL1 read from the memory 74 (step St5). When it is determined that the detection value of the photosensor PD2 is greater than the upper limit threshold (step St5, NO), the head processing unit 73 determines that there is a risk of damage to the optical element inside the laser head 60 (for example, around the lower head block 62), controls turning off of the laser driving power supply (not illustrated) for stopping the operation of the laser processing device 100, generates the screen indicating the warning alarm (message) for prompting the operator to clean or replace the optical element, and displays the screen on the display DP1 (step St6). After step St6, the processing of the head processing unit 73 illustrated in FIG. 7 ends.

On the other hand, when it is determined that the detection value of the photosensor PD2 is equal to or less than the upper limit threshold (steps St5, YES), the head processing unit 73 determines whether the detection value of the photosensor PD2 is equal to or greater than the lower limit threshold corresponding to the current operation program, oscillation mode, and command of the laser beam LB (step St7). When it is determined that the detection value of the photosensor PD2 is less than the lower limit threshold (step St7, NO), the head processing unit 73 determines that there is a high possibility that an abnormality has occurred in the equipment (for example, the laser oscillator 10, the optical unit 20, or the optical fiber 30) disposed upstream of the laser head 60, controls turning off of the laser driving power supply (not illustrated) for stopping the operation of the laser processing device 100, generates the screen indicating the warning alarm (message) for prompting the operator to inspect or replace the device (refer to the above description), and displays the screen on the display DP1 (step St8). After step St8, the processing of the head processing unit 73 illustrated in FIG. 7 ends.

On the other hand, when it is determined that the detection value of the photosensor PD2 is equal to or greater than the lower limit threshold (steps St7, YES), the head processing unit 73 determines that there is no abnormality in the detection value of the photosensor PD2.

After step St7, when an irradiation command of the laser beam LB from the laser control unit 71 to the laser oscillator 10 is on (that is, ongoing) (steps St9, YES), the processing of the head processing unit 73 returns to step St1. On the other hand, when the irradiation command of the laser beam LB from the laser control unit 71 to the laser oscillator 10 is not on (that is, ongoing) (step St9, NO), the processing of the head processing unit 73 illustrated in FIG. 7 ends.

### Regarding Techniques of Present Disclosure

As described above, the present disclosure discloses the following technical ideas.

### Technique 1

A laser processing device including: at least,
a laser oscillator (the laser oscillator 10) configured to generate a laser beam;
a laser head (the laser head 60) configured to irradiate a workpiece (the workpiece 200) with the laser beam; and
a control unit (the laser control unit 71), in which
the laser head accommodates at least
   a first lens (the collimation lens CLL1 and the condensing lens FCL1) for condensing the laser beam toward the workpiece,
   a first glass (the protective glasses SG1 and SG2) that transmits the laser beam, and
   one or more first sensors (the photosensors PD1 and PD2) disposed between the first lens and the first glass in an irradiation direction of the laser beam to the workpiece, and
the control unit detects presence or absence of an abnormality in at least one of the first lens and the first glass based on a detection output of the first sensor.

Accordingly, the laser processing device can easily detect the presence or absence of an abnormality (for example, contamination, a scratch, or deterioration) of an optical element or the like inside the laser head 60 by determination using the detection output of the photosensor PD1 or the photosensor PD2 disposed inside the laser head 60 that irradiates the workpiece 200 with the laser beam (that is, the laser beam LB).

### Technique 2

The laser processing device according to Technique 1, in which
the laser head further accommodates
   a second lens (the condensing lens FCL1 and the collimation lens CLL1) for condensing the laser beam toward the workpiece,
   a second glass (the protective glasses SG2, SG1) that transmits the laser beam, and
   one or more second sensors (the photosensors PD2 and PD1) disposed between the second lens and the second glass in the irradiation direction of the laser beam to the workpiece, and
the control unit further detects presence or absence of an abnormality in at least one of the second lens and the second glass based on a detection output of the second sensor.

As a result, the laser processing device can easily and specifically detect the presence or absence of an abnormality (for example, contamination, a scratch, or deterioration) of the optical element or the like inside the laser head 60 by the detection output of the photosensor according to the arrangement location even when the photosensors are disposed at a plurality of locations inside the laser head 60 by the determination using the detection output of the photosensor PD2 or the photosensor PD1 disposed inside the laser head 60.

### Technique 3

The laser processing device according to Technique 1 or Technique 2, in which
the control unit displays a detection result of the presence or absence of an abnormality in at least one of the first lens and the first glass on a display (the display DP1).

Accordingly, an operator who handles the laser processing device can visually recognize and grasp the detection result of the presence or absence of an abnormality (for example, contamination, a scratch, or deterioration) in at least one of the first lens (the collimation lens CLL1 and the condensing lens FCL1) and the first glass (the protective glasses SG1 and SG2).

### Technique 4

The laser processing device according to Technique 1, in which
a plurality of the first sensors are disposed so as to surround the first glass when viewed in a plane direction orthogonal to the irradiation direction of the laser beam to the workpiece.

Accordingly, the laser processing device can multilaterally and comprehensively determine the presence or absence of an abnormality (for example, contamination, a scratch, or deterioration) of the first glass (the protective glasses SG1 and SG2) by the detection outputs of the plurality of first sensors (the photosensors PD1 and PD2).

### Technique 5

The laser processing device according to Technique 2, in which
a plurality of the second sensors are disposed so as to surround the second glass when viewed in a plane direction orthogonal to the irradiation direction of the laser beam to the workpiece.

As a result, the laser processing device can multilaterally and comprehensively determine the presence or absence of an abnormality (for example, contamination, a scratch, or deterioration) of not only the first glass (the protective glasses SG1 and SG2) but also the second glass (the protective glasses SG2 and SG1) by the detection outputs of the plurality of second sensors (the photosensors PD2 and PD1).

### Technique 6

The laser processing device according to any one of Techniques 1 to 5, in which
the control unit detects the presence or absence of an abnormality in at least one of the first lens and the first glass based on a comparison between the detection output of the first sensor and a threshold (the threshold 5) that is a normal detection value of the first sensor.

Accordingly, the laser processing device can easily and appropriately detect the presence or absence of an abnormality (for example, contamination, a scratch, or deterioration) of the optical element or the like inside the laser head 60 by the determination based on the comparison between the detection outputs of the photosensors PD1 and PD2 disposed inside the laser head 60 that irradiates the workpiece 200 with the laser beam (that is, the laser beam LB) and the threshold.

### Technique 7

The laser processing device according to Technique 1, in which
the first glass is disposed on an upper side of the laser head and between an optical fiber (the optical fiber 30) that guides the laser beam from the laser oscillator and the first lens,
the first lens is a collimation lens (the collimation lens CLL1) that collimates the laser beam transmitted through the first glass, and
the control unit detects presence or absence of an abnormality in at least one of the first glass and the collimation lens based on the detection output of the first sensor.

Accordingly, the laser processing device can appropriately detect the presence or absence of an abnormality (for example, contamination, a scratch, or deterioration) of at least one of the protective glass SG1, which is disposed on the upper side of the laser head 60 and disposed between the optical fiber 30 and the collimation lens CLL1, and the collimation lens CLL1.

### Technique 8

The laser processing device according to Technique 2, in which
the second lens is a condensing lens (the condensing lens FCL1) that condenses the laser beam LB transmitted through the first lens (the collimation lens CLL1) toward the workpiece,
the second glass is a protective glass (the protective glass SG2) that is disposed on a lower side of the laser head and prevents entry of scattered deposits (for example, fumes and spatters) from the workpiece into the laser head, and
the control unit detects presence or absence of an abnormality in at least one of the protective glass and the condensing lens based on the detection output of the second sensor.

As a result, the laser processing device can appropriately detect the presence or absence of an abnormality (for example, contamination, a scratch, or deterioration) in at least one of the protective glass SG2, which is disposed on the lower side of the laser head 60 and prevent the entry of the scattered deposits from the workpiece 200 into the laser head 60, and the condensing lens FCL1.

### Technique 9

The laser processing device according to Technique 4, in which
the plurality of first sensors have detection sensitivities of the laser beam in different wavelength bands, respectively.

Accordingly, since the plurality of first sensors (for example, the photosensors PD1a, PD1b, and PD1c) have the detection sensitivities of the laser beam LB in different wavelength bands, the laser processing device can receive the scattered light or the like of the laser beam LB with a high sensitivity in a wide wavelength band, and can accurately detect the presence or absence of an abnormality (for example, contamination, a scratch, or deterioration) inside the laser head 60 (particularly, in the vicinity of the upper head block 61).

### Technique 10

The laser processing device according to Technique 5, in which
the plurality of second sensors have detection sensitivities of the laser beam in different wavelength bands, respectively.

Accordingly, since the plurality of second sensors (for example, the photosensors PD2a, PD2b, and PD2c) have the detection sensitivities of the laser beam LB in different wavelength bands, the laser processing device can receive the scattered light or the like of the laser beam LB with a high sensitivity in a wide wavelength band, and can accurately detect the presence or absence of an abnormality (for example, contamination, a scratch, or deterioration) inside the laser head 60 (particularly, in the vicinity of the lower head block 62).

### Technique 11

The laser processing device according to any one of Techniques 1 to 10, in which
the laser beam is blue laser beam having a blue wavelength band.

As a result, when performing laser processing using blue laser beam (blue laser beam), the laser processing device can easily detect the presence or absence of an abnormality (for example, contamination, a scratch, or deterioration) of the optical element or the like inside the laser head 60 by determination using the detection output of the photosensor PD1 or the photosensor PD2 disposed inside the laser head 60 that irradiates the workpiece 200 with the laser beam (that is, the laser beam LB).

### Technique 12

A laser head abnormality detection method executed by a laser processing device,
the laser processing device including: at least,
a laser oscillator configured to generate a laser beam;
a laser head configured to irradiate a workpiece with the laser beam; and
a control unit,
the laser head accommodating at least
   a first lens for condensing the laser beam toward the workpiece,
   a first glass that transmits the laser beam, and
   one or more first sensors disposed between the first lens and the first glass in an irradiation direction of the laser beam to the workpiece,
the method including:
   a step of, by the control unit, acquiring a detection output of the first sensor; and
   a step of, by the control unit, detecting presence or absence of an abnormality in at least one of the first lens and the first glass based on the detection output of the first sensor.

Accordingly, according to the laser head abnormality detection method, it is possible to easily detect the presence or absence of an abnormality (for example, contamination, a scratch, or deterioration) of the optical element or the like inside the laser head 60 by determination using the detection output of the photosensor PD1 or the photosensor PD2 disposed inside the laser head 60 that irradiates the workpiece 200 with the laser beam (that is, the laser beam LB).

Although various embodiments have been described above with reference to the drawings, it is needless to say that the present disclosure is not limited to such examples. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the various embodiments described above may be combined freely in a range without deviating from the spirit of the invention.

In the present embodiment described above, an example in which the threshold 4 is provided as the lower limit threshold has been described, but the lower limit threshold may be provided in two stages, and the head processing unit 73 may determine whether the value is below the lower limit threshold based on a comparison with a past log (for example, past detection values of the photosensors PD1 and PD2 in a certain period (for example, one month ago) stored in the memory 74) instead of the lower limit threshold or in combination with the lower limit threshold. Accordingly, the head processing unit 73 can analyze in detail whether an abnormality has occurred due to a change over time or an abnormality has occurred due to a sudden change, and can perform detailed cause analysis by collating with monitoring data of the laser oscillator 10 stored in the memory 74, for example.

The present application is based on a Japanese patent application filed on Dec. 25, 2023 (JP 2023-218463A), and contents thereof are incorporated herein by reference.

### INDUSTRIAL APPLICABILITY

The present disclosure is useful as a laser processing device and a laser head abnormality detection method for easily detecting the presence or absence of an abnormality in an optical element or the like inside a laser head that irradiates a workpiece with a laser beam.

What is claimed is:

1. A laser processing device comprising: at least,
a laser oscillator that generates a laser beam;
a laser head that irradiates a workpiece with the laser beam; and
a control unit, wherein
the laser head accommodates at least
a first lens for condensing the laser beam toward the workpiece,
a first glass that transmits the laser beam, and
one or more first sensors disposed between the first lens and the first glass in an irradiation direction of the laser beam to the workpiece, and
the control unit detects presence or absence of an abnormality in at least one of the first lens and the first glass based on a detection output of the first sensor.

2. The laser processing device according to claim 1, wherein
the laser head further accommodates
a second lens for condensing the laser beam toward the workpiece,
a second glass that transmits the laser beam, and
one or more second sensors disposed between the second lens and the second glass in the irradiation direction of the laser beam to the workpiece, and
the control unit detects presence or absence of an abnormality in at least one of the second lens and the second glass based on a detection output of the second sensor.

3. The laser processing device according to claim 1, wherein
the control unit displays a detection result of the presence or absence of an abnormality in at least one of the first lens and the first glass on a display.

4. The laser processing device according to claim 1, wherein
a plurality of the first sensors are disposed so as to surround the first glass when viewed in a plane direction orthogonal to the irradiation direction of the laser beam to the workpiece.

5. The laser processing device according to claim 2, wherein
a plurality of the second sensors are disposed so as to surround the second glass when viewed in a plane direction orthogonal to the irradiation direction of the laser beam to the workpiece.

6. The laser processing device according to claim 1, wherein
the control unit detects the presence or absence of an abnormality in at least one of the first lens and the first glass based on a comparison between the detection output of the first sensor and a threshold that is a normal detection value of the first sensor.

7. The laser processing device according to claim 1, wherein
the first glass is disposed on an upper side of the laser head and between an optical fiber that guides the laser beam from the laser oscillator and the first lens,
the first lens is a collimation lens that collimates the laser beam transmitted through the first glass, and
the control unit detects presence or absence of an abnormality in at least one of the first glass and the collimation lens based on the detection output of the first sensor.

8. The laser processing device according to claim 2, wherein
the second lens is a condensing lens that condenses the laser beam transmitted through the first lens toward the workpiece,
the second glass is a protective glass that is disposed on a lower side of the laser head and prevents entry of scattered deposits from the workpiece into the laser head, and
the control unit detects presence or absence of an abnormality in at least one of the protective glass and the condensing lens based on the detection output of the second sensor.

9. The laser processing device according to claim 4, wherein
the plurality of first sensors have detection sensitivities of the laser beam in different wavelength bands, respectively.

10. The laser processing device according to claim 5, wherein
the plurality of second sensors have detection sensitivities of the laser beam in different wavelength bands, respectively.

11. The laser processing device according to claim 1, wherein
the laser beam is blue laser beam having a blue wavelength band.

12. A laser head abnormality detection method executed by a laser processing device,
the laser processing device including: at least,
a laser oscillator that generates a laser beam;
a laser head that irradiates a workpiece with the laser beam; and
a control unit,
the laser head accommodating at least
a first lens for condensing the laser beam toward the workpiece,
a first glass that transmits the laser beam, and
one or more first sensors disposed between the first lens and the first glass in an irradiation direction of the laser beam to the workpiece,
the method comprising:
by the control unit, acquiring a detection output of the first sensor; and
by the control unit, detecting presence or absence of an abnormality in at least one of the first lens and the first glass based on the detection output of the first sensor.
